(19) United States
(12) Patent Application Publication
(10) Pub. No.: US 2011/0276305 A1
(43) Pub. Date: Nov. 10, 2011

(54) METHOD AND SYSTEM FOR MODELLING ROTARY ACCELERATIONS OF A VESSEL

(75) Inventors: Arne Rinnan, Ranheim (NO); Finn Otto Sanne, Trondheim (NO); Terje Bogfjellmo, Trondheim (NO); Thor Hukkelaas, Kongsberg (NO); Edgar Johansen, Trondheim (NO); Ola Erik Fjellstad, Trondheim (NO)

(73) Assignee: KONGSBERG SEATEX AS, Trondheim (NO)

(21) Appl. No.: 13/144,742

(22) PCT Filed: Aug. 27, 2010
(86) PCT No.: PCT/NO2010/000318

§ 371 Date: Jul. 15, 2011

(30) Foreign Application Priority Data
Sep. 16, 2009 (NO) 20093007

(51) Int. Cl. G06F 15/00; G01P 3/00; G01P 15/00

(52) U.S. Cl. 702/141

(57) ABSTRACT

Method and system for modeling angular accelerations of a vessel, so that forces/accelerations in real time and with a high degree of accuracy can be transformed to any other point on the vessel or in the vicinity of the vessel, provided that the vessel can be considered as a rigid body and that the vessel does not perform loops or rolls as a part of its general movement pattern.

The present invention relates to a method and system for modeling angular accelerations, so that forces/accelerations in real time and with a high degree of accuracy can be transformed to any other position on the vessel or in the vicinity of the vessel, according to the preamble of claims 1 and 16, respectively.

### BACKGROUND

Increasing use of vessels in complicated operations results in that the need for having control over forces acting between vessels and, for example, a load or different points on a vessel, has become more important than earlier. Examples are forces affecting a load on deck, movements in the tip of a crane, or forces affecting a pipeline being deployed from the vessel. Vessels and operations will generally act in accordance with limits for forces which are allowed for an operation to be safe.

Accelerometers can be used to measure forces in a given point on a vessel. If all movements were linear one could theoretically arrange triple axis accelerometers anywhere on the vessel, and assume that the same forces apply in any other point. An important part of a vessel's movements is however rotations about all three axes induced by wind and waves. This means that forces (accelerations) measured in a point on the vessel not nearly represent forces in a different point. As it is expensive and many times difficult to arrange accelerometers in all positions where it is interesting to measure forces, it is desirable to be able to transform measurements from one point to another. As the vessels generally are large constructions it is desirable to be able to perform such transformations over large distances of several tens of meters with high accuracy.

One kind of instrument which can be used to perform such transformations are so-called AHRS (“Attitude & Heading Reference Systems”) which in the principle consists of three accelerometers and three gyros, which in basis measures angular velocity and linear accelerations in six degrees of freedom. An example of such instruments is MRU products provided by the applicant. Transforming position and velocity from the monitoring point to another point of the vessel is considered to be trivial with such an instrument. As regards transformation of forces (accelerations) one is, due to that the basis measurement from the gyro being angular velocity, dependent of deriving this to be able to transform the acceleration measurements to a different point. The problem is however that measuring noise highly limits the accuracy.

A method for reducing the effect of measuring noise is, for example, by utilizing a Kalman filter modeling the movements of the vessel (position, velocity and acceleration), and which is updated with measurements from, among others, one or more AHRS. One can thus indirectly acquire the forces (accelerations) from the updated vessel model, as an alternative to direct sensor measurements. The quality of the solutions is however limited to how well the static model of the vessel (Kalman filter) represents the actual vessel and its response to waves and wind.

### Object

The main object of the present invention is to improve the above mentioned problems by providing a method and a system for reducing the effect of the measuring noise, and thus increase the accuracy of measurements and transformations.

It is further an object of the invention to model angular accelerations of an vessel by means of independent oscillators in roll and pitch direction, driven by measurements from an instrument which in a given monitoring point registers all linear accelerations and angular velocities, so that forces (accelerations) in real time and with a high degree of accuracy, can be transformed to any other point of the vessel.

It is further an object of the present invention to provide a system and method which can combine measurements from an arbitrary number of measuring instruments arranged in an arbitrary number of points, and that this can be performed with a high degree of accuracy and integrity.

Finally it is an object that all transformations are performed in real time to an arbitrary number of physical or virtual points on or in the vicinity of the vessel.

### The Invention

A method according to the invention is described in claim 1. Preferable features of the method are described in claims 2-15.

A system according to the invention is described in claim 16. Preferable features of the system are described in claims 17-20.

According to the invention it is provided a method for reducing the effect of measuring noise from measuring instruments and increasing the accuracy in measurements and transformations. The method takes basis in measurements from one or more arbitrary arranged measuring instruments, such as one or more MRUs or similar, which provides information about the movements of the vessel. The method is especially directed to modeling the vessel with regard to relevant rotations by utilizing independent harmonic oscillators which each represents roll and pitch movements. In a statistic view this is favorable, as the average value of these movements necessarily must be zero for a general vessel. The most vessels are also constructed so that the connection between roll and pitch will be weak. Such a method will thus be very suitable as a basis for transforming accelerations from a monitoring point, where one already are measuring both accelerations and angular velocity, to one or more arbitrary points onboard or in the vicinity of the vessel.

This results in that forces (accelerations) in real time and with a high degree of accuracy can be transformed to any other point on the vessel, provided that the vessel can be considered as a rigid body, and that the vessel does not perform loops or rolls as a part of its general moving pattern.

As mentioned introductorily, it is known to use a Kalman filter for modeling movements (position, velocity and acceleration) of a vessel, but the quality of this solution is limited to how well the Kalman filter represents the actual vessel and its response to waves and wind.

The present method is based on, among others, a Kalman filter approach, but by utilizing independent harmonic oscillators which each represents roll and pitch movements. The Kalman filter is, among others, used for estimating angular acceleration based on measurements from one or more measuring instruments, such as one or more MRUs, onboard a vessel.

By calculating lateral velocity and acceleration levels at given points onboard a vessel, based on measurements from one or more measuring instruments, i.e. by using lever arm calculations, it is important that there exists good and noise free estimates of both angular velocities and angular accelerations. Monitoring of lateral velocity and acceleration levels are important parts of products as monitoring systems for helideck, vessel movements and similar systems or descents of these.

Linear velocities and accelerations at a given point is calculated as the sum of the linear components in the position of the measuring instrument, in addition to contributions from angular velocities and angular accelerations, which can be expressed in the following two equations for velocity and acceleration in a given point mp:

vₘₚ^{h}=v_{measuring}_{_{—}}ᵢₙₛₜᵣᵤₘₑₙₜ^{h}+C_{b}^{h}(ω_{bh}×r^{b}) (Eq. 1)

aₘₚ^{h}=a_{measuring}_{_{—}}ᵢₙₛₜᵣᵤₘₑₙₜ^{h}+C_{b}(\dot{ω}\dot{ω_{bh}}×r^{b}+ω_{bh}×(ω_{bh}×r^{b})) (Eq. 2)

where:

h: Heading

b: Body

mp: Monitoring point

C_{b}^{h}(Θ): Rotational matrix from body to heading frame

ω_{bh}: Angular velocities for body frame, relative to heading frame

One can see from the equations above that the noise of the angular acceleration estimates (\dot{ω}\dot{ω_{bh}}) are amplified with the distance or length of the vector between the measuring instrument and the given point.

The estimates of the angular accelerations from the measuring instrument are based on simple numerical derivation of measured angular rates and are accordingly quite noisy:

$$a ( k ) = \frac{v ( k ) - v ( k - 1 )}{dt} \qquad ( Eq . 2.1 )$$

Where dt is time step or sampling interval, while k denotes the current time step, while k−1 denotes previous time step.

By a Kalman filter approach according to the invention one can thus find the best possible optimum estimates for angular accelerations based on angle and/or angular velocity measurements from a measuring instrument, such as a MRU. The Kalman filter approach according to the invention is based on modeling angular accelerations of a vessel by means of independent oscillators in roll, pitch and/or heave direction, which oscillators are driven by measurements from measuring instruments in given monitoring points onboard a vessel. The method will further include a way to combine measurements from several measuring instruments, arranged at suitable points of a vessel, to provide transformed movements of an arbitrary number of points. It is a condition that this is done with high accuracy and integrity. By means of the method it is possible to perform transformations in real time to an arbitrary number of physical or virtual points on or in the vicinity of the vessel.

The method according to the invention can be summarized in the following steps:
a) acquiring measurements from one or more measuring instruments arranged in given monitoring points onboard a vessel,
b) calculating position, velocity and accelerations for given monitoring points,
c) combining measurements from an arbitrary number of measuring instruments, arranged in arbitrary points to provide transformed movements to an arbitrary number of points,
d) transforming in real time to an arbitrary number of physical or virtual points on or in the vicinity of the vessel,
e) continuously repeating the steps a)-d).

Step a) includes acquiring values/measurements from measuring instruments arranged at given monitoring points on a vessel, which measuring instruments includes one or more of the following: MRU, IMU, VRU, accelerometers, gyroscope, combined IMU/GNSS system or similar.

Step b) includes calculating position, velocity and accelerations for given monitoring points by means of a Kalman filter according to the invention. The Kalman filter according to the invention includes oscillators driven by measurements from the measuring instruments. The parameters of the oscillators in the Kalman filter is further adapted to the actual vessel based on modeling or practical measurements. The Kalman filter can further be arranged for only the use of angle measurements, only angular velocity measurements or by the use of both angular velocity measurements and angle measurements. The Kalman filter can further be arranged for constant gain or variable gain.

Step c) includes combining angle measurements from different measuring instruments. The step includes:
1. calculating the average value of the gravitational vector by using readings from vertically arranged measuring instruments,
2. calculating average value of error angles in roll and pitch for each measuring instrument,
3. subtracting the error angles from the roll and pitch measurements for each measuring instrument,
4. making pseudo measurements by weighting together each corrected measurement by using measurement covariance of each measuring instrument.

This is done with high accuracy and integrity.

Step d) includes transforming in real time forces (accelerations) to an arbitrary number of physical or virtual points on or in the vicinity of the vessel, with a high degree of accuracy. It is provided that the vessel may be considered as a rigid body and that the vessel does not perform loops or rolls as a part of its general moving pattern. The calculated values for angular accelerations in the point of the measuring instrument is referred to as a geographical frame, while linear accelerations are referred to as the heading frame. Accordingly, contributions to linear accelerations in a monitoring point, due to the angular acceleration, are rotated from geographical frame to the heading frame. The calculated linear accelerations in a monitoring point then becomes the sum of the linear components from the measuring instrument and the transformed contributions from the angular accelerations.

Step e) includes repeating the steps a)-d) as long as it is desirable to transform forces (accelerations).

The invention further includes a system for executing the method. The system can be independent or integrated in an existing monitoring system, such as monitoring systems for helideck, vessel movements or similar. An example of such a monitoring system is the applicant's own “Vessel Motion Monitor—VMM 200”. Such a system usually has one or more of the following functions:
providing an interface for movement, position and weather sensors,
making it possible for the user to monitor the movement in each point of the vessel,
providing a warning to the user if values exceeds predefined limits,
perform statistical analysis and present the result in real time,
register data as time series of user defined lengths,
making it possible for the user to see registered data and perform different types of analysis of registered data.

It is especially in connection with monitoring of a given point, either onboard the vessel or in the vicinity of the vessel, that the present invention provides great improvement in relation to existing systems. By the above described method it is possible to transform forces (accelerations) from one given point (monitoring point) to an arbitrary number of points onboard the vessel or in the vicinity of the vessel.

A system according to the invention for this includes a control unit, either integrated in an existing monitoring system, a unit arranged/connected to an existing monitoring system or an independent unit. The system further includes one or more measuring instruments arranged at suitable points onboard a vessel, either existing measuring instruments or measuring instruments specific arranged for the system, such as one or more of: MRU, IMU, VRU, accelerometer, gyroscope, combined IMU/GNSS system or similar systems for measuring values, preferably registering linear accelerations and angular velocities, in a given point where the measuring instrument is arranged. The control unit is further preferably provided with means and/or provided with software/algorithms for executing the method, including a Kalman filter according to the invention including the independent harmonic oscillators.

If the control device is arranged to or integrated in an existing monitoring system, it can use monitors the system has to display information, but if it is a independent unit, the system preferably includes a separate monitor for this.

Results of the method can be used for, among others, controlling the vessel and controlling equipment arranged to the vessel, such as cranes and similar. A monitoring point may be defined as, positioned on equipment such that movements can be monitored in relation to the coordinate system of the vessel, or in a geographical coordinate system. The latter will make it possible to monitor movements in relation to fixed points outside the vessel. This can be fixed points, such as other vessels, fixed constructions and natural formations. Movements in monitoring points in relation to each other can also be monitored to avoid damage of equipment.

Limitations in motions for a set of monitoring points can be planed over time, so that an operation can be monitored and aborted if the limits for one of these monitoring points are exceeded. This can, for example, be used for complex offshore operations, as arrangement of production modules at large sea depths, with sub operations as loading of modules from a barge to a vessel with cranes, movements of modules on vessel deck or lowering of modules through the moonpool of the vessel to the seabed.

Another application can be monitoring of loads on containers arranged on a container ship, to prevent that the load on fastening devices are exceeded during high sea.

Results from the method can also be used to a large extent as a decision support system for operation offshore, when operations can and should start and if an ongoing operation must be stopped because movements exceed or are close to the limits which are set for the performing of the operation. Typical operations are movement of modules on loading deck, performing crane operations, controlling/guiding well tools through narrow valves in a drill pipe or riser at light well intervention operations, and helicopter operations on movable helidecks.

Further preferable features and details of the invention will appear from the following example description.

### EXAMPLE

The invention will below be described in detail with references to the attached drawings, wherein:

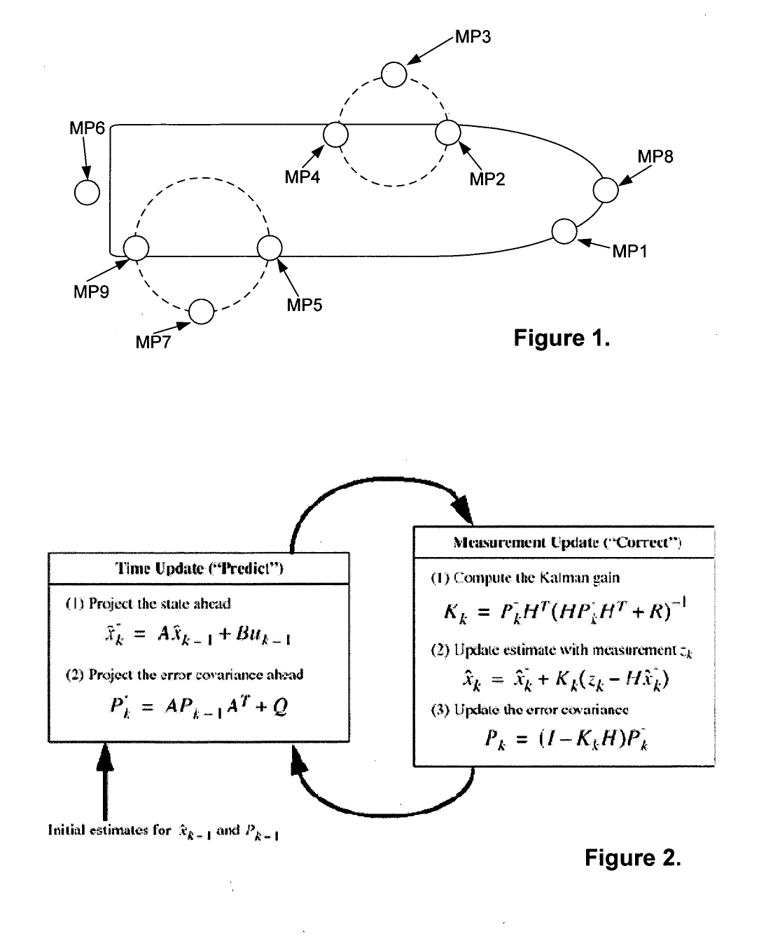

FIG. 1 is a sketch of a vessel and typical points where monitoring is desirable,

FIG. 2 schematically illustrates time and measurement update for a linear, discrete Kalman filter,

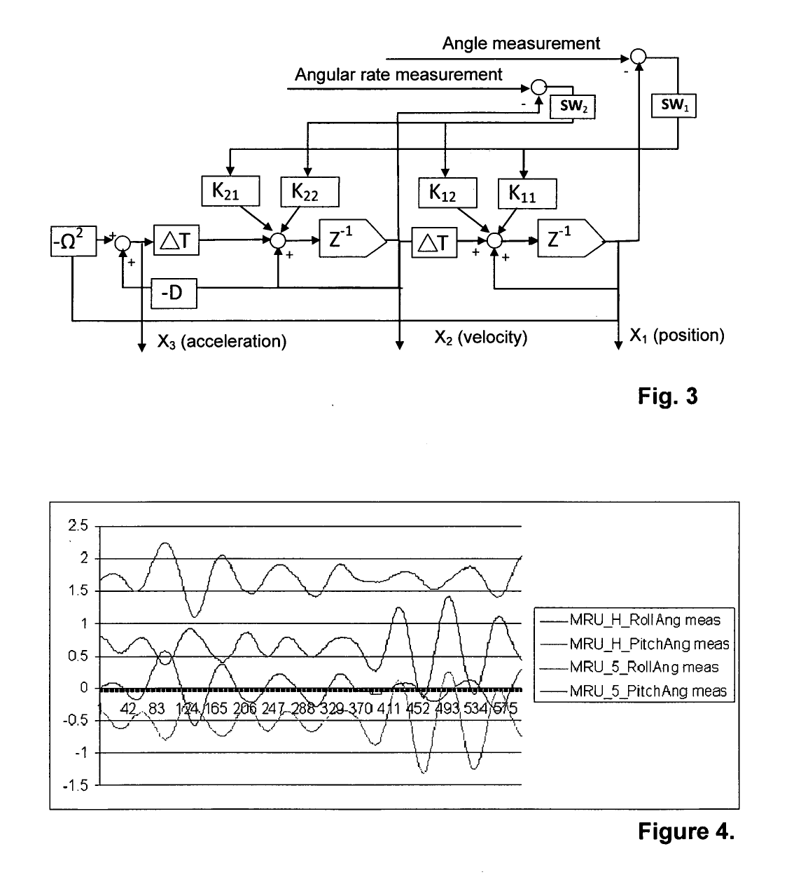

FIG. 3 is a block diagram for a discrete Kalman filter according to the invention,

FIG. 4 shows a comparison between a precisely arranged measuring instrument and a inaccurately arranged measuring instrument,

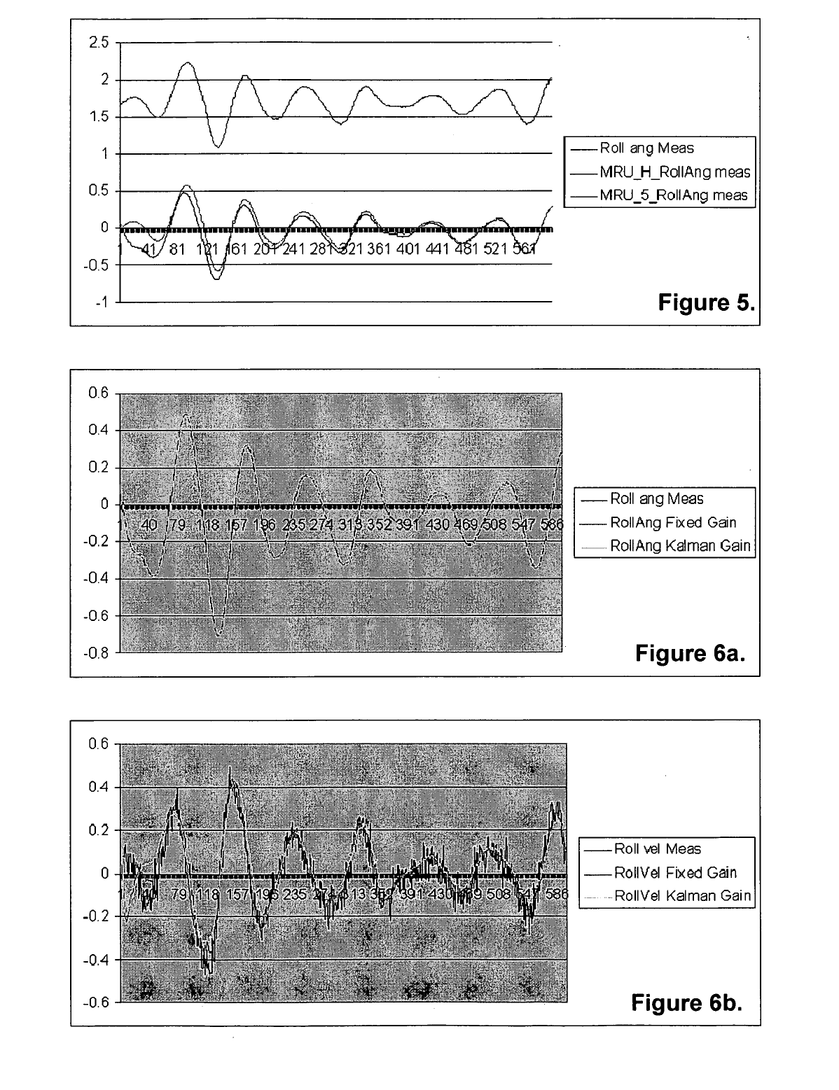

FIG. 5 shows simulations of measured roll angles from measuring instruments and a resulting weighted roll angle measurement,

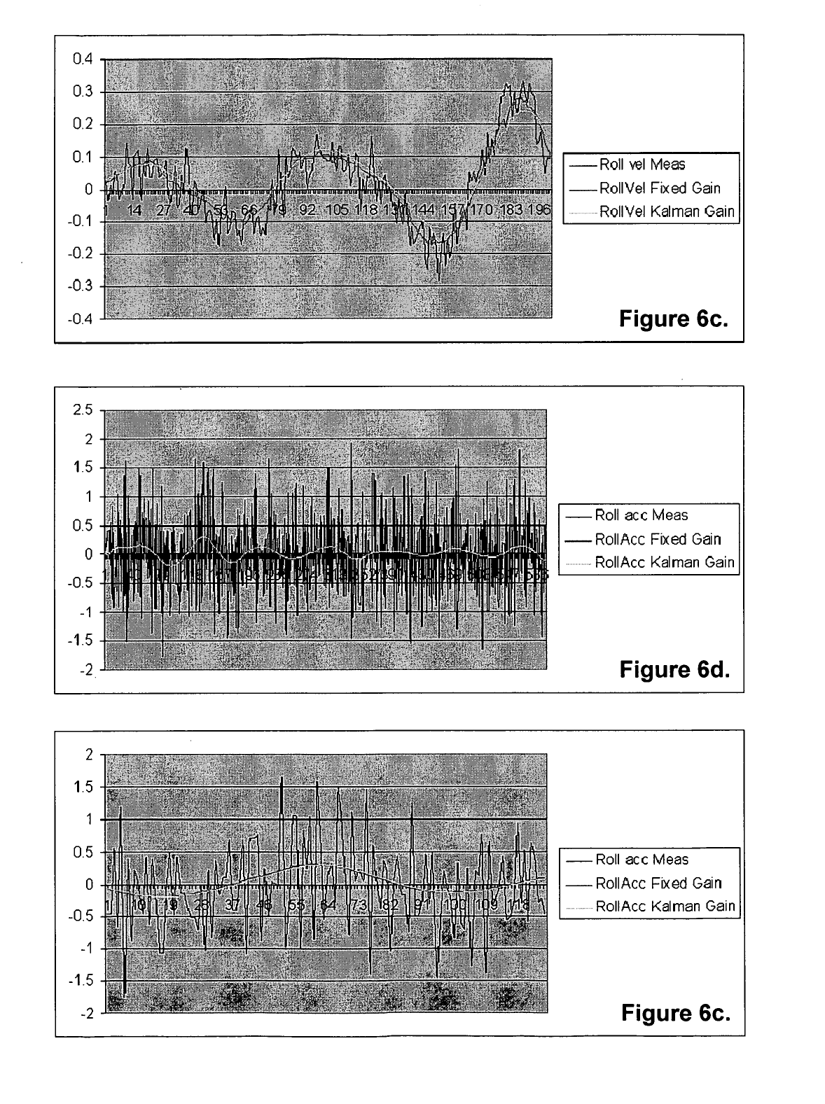

FIG. 6a shows simulation results for roll angle,

FIG. 6b-c shows simulation results for roll velocity,

FIG. 6d-e shows simulation results for roll acceleration,

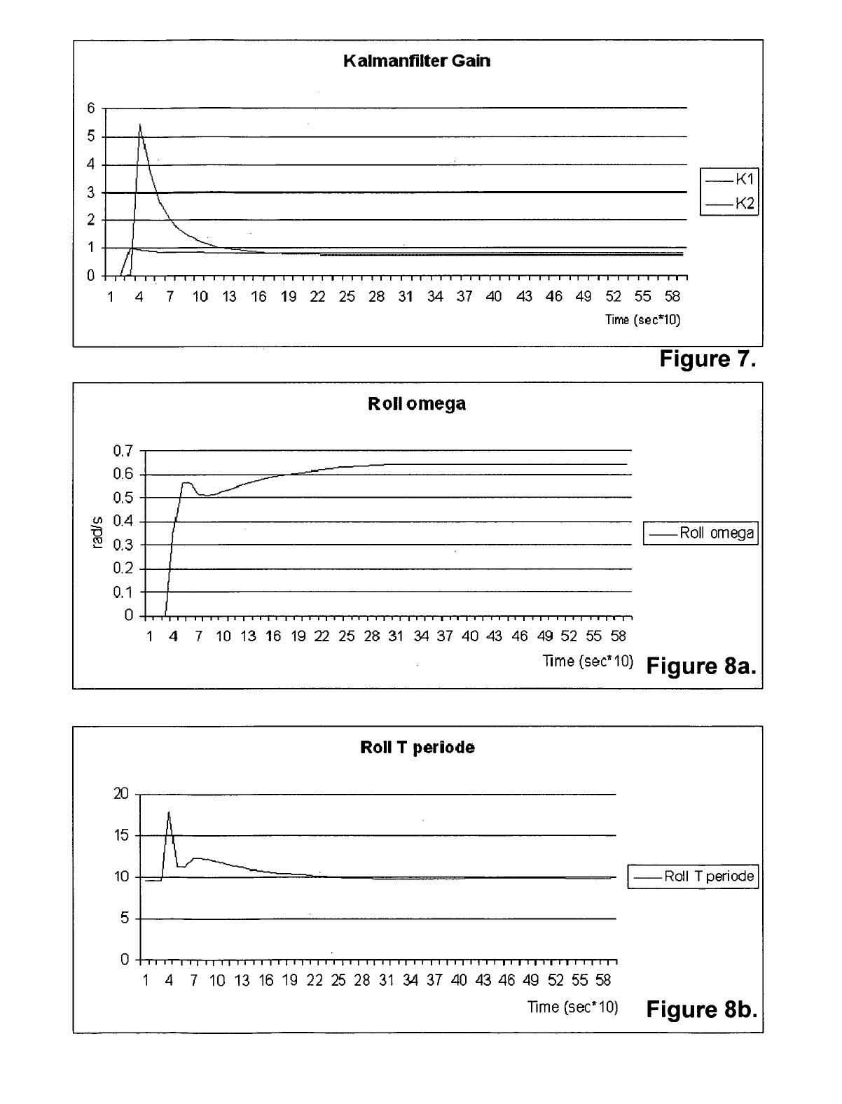

FIG. 7 shows simulation of the development in Kalman filter gains over time,

FIG. 8a-b shows simulations of estimates for angular velocities and the corresponding roll period, and

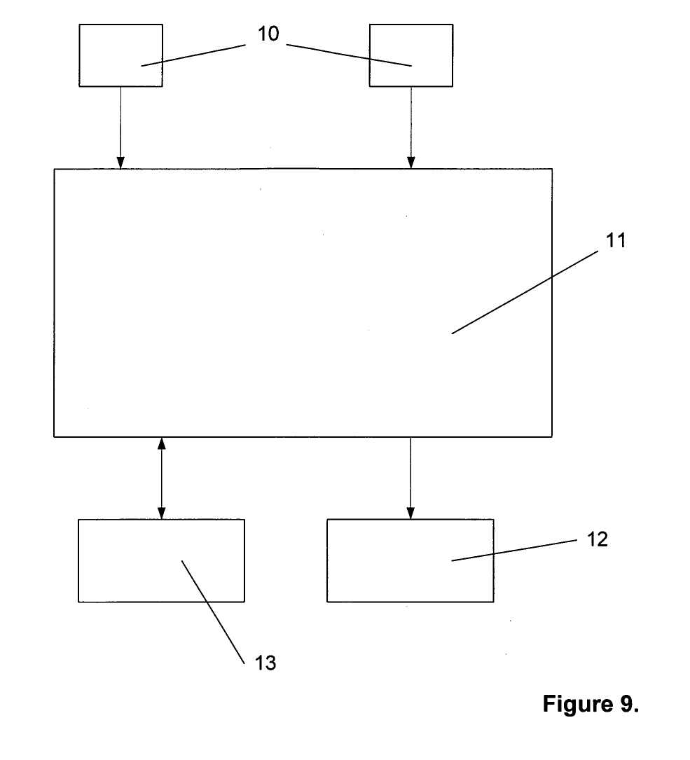

FIG. 9 is a block diagram for a system according to the invention.

To be able to understand the present invention it is a presumption to know Kalman filter technology. Below is therefore a short and general introduction of Kalman filter theory, while it for detailed explanations are referred to, for example, “An Introduction to the Kalman Filter, by Greg Welch and Gary Bishop, TR 95-041 Department of Computer Science, University of North Carolina at Chapel Hill, Chapel Hill, N.C. 27599-3175”.

The Kalman filter addresses the general problem of trying to estimate the state xₖ=ε [symbol] of a discrete time controlled process that is governed by the linear stochastic difference equation:

xₖ=Axₖ₋₁+Buₖ+wₖ₋₁ (Eq. 3)

with a measurement zₖ=ε [symbol] that is:

zₖ=Hxₖ+vₖ (Eq. 4)

The random variables wₖ and vₖ represents the process and measurement noise, respectively. They are assumed to be independent of each other, white, and with normal probability distributions:

p(w)≈N(0,Q) (Eq. 5.1)

p(v)≈N(0,R) (Eq. 5.2)

In practice, the process noise covariance matrix Q and measurement noise covariance matrix R are changed with each time step or measurement, however here we assume that they are constant.

The matrix A in the difference equation (Eq. 3) relates to states at the previous time step k−1 of the state at the current step k, in the absence of either a driving function or process noise. In practice A might change with each time step. The n×l matrix B relates to optional control input to the state x, while the m×n matrix H in the measurement equation (Eq. 4) relates to the state of the measurement zₖ.

We define x̅=δ [symbol] to be our a priori estimate at the step k, provided the knowledge of the process prior to step k, and \hat{x}=ε [symbol] to be our a posteriori estimate at the step k provided the measurement zₖ. We can also define a priori and a posteriori estimate errors as follows:

ēₖ≡xₖ− x̅ₖ (Eq. 6.1)

êₖ≡xₖ−\hat{x}ₖ (Eq. 6.2)

a priori estimate error covariance is as follows:

P̅ₖ=E[ēₖēₖ^{T}] (Eq. 6.3)

and a posteriori estimate error covariance is:

\hat{P}ₖ=E[êₖêₖ^{T}] (Eq. 6.4)

In deriving the equations for the Kalman filter the goal is to find an equation which calculates a posteriori state estimate \hat{x}ₖ as a linear combination of an a priori estimate x̅ₖ and a weighted difference between the actual measurement zₖ and a measurement prediction H· x̅ₖ as shown below:

\hat{x}ₖ= x̅ₖ+K·(zₖ−H· x̅ₖ) (Eq. 7)

The difference (zₖ−H· x̅ₖ) is called measurement innovation or the residual. The residual reflects the discrepancy between the predicted measurement H· x̅ₖ and the actual measurement zₖ. A residual of zero means that the two are in complete agreement.

n×m matrix K in equation 7 is chosen to be the gain or blending factor which minimizes the a posteriori error covariance. One form of K that minimizes this covariance is:

Kₖ= P̅ₖH^{T}(H P̅ₖH^{T}+R)^{31 1} (E. 8.1)

The Kalman filter estimates a process by using a form of feedback control. This is done by that the Kalman filter estimates the process state at some time and then achieves a feedback in the form of (noise) measurements. These equations for the Kalman filter fall in two groups:

1) time update equations, and

2) measurement update equations.

The time update equations are responsible for projecting forward (in time) the present state and error covariance estimates to achieve the a priori estimates for the next time step, while the measurement update equations are responsible for the feedback, i.e. for incorporating a new measurement into the a priori estimate for achieving an improved a posteriori estimate. The time update equations can also be thought of as predictor equations, while the measurement update equations can be thought of as corrector equations. This is illustrated in FIG. 2 as prediction and correction equations for a linear, discrete Kalman filter.

With the basis of the above described, roll and pitch movements, and also heave movements if desirable, for a vessel can be modeled according to the invention as independent harmonic oscillators. This is based on the assumption that the vessel does not performs any loops or rolls, i.e. that the average roll, pitch and heave velocities are zero. According to the invention an oscillator can be described by the following equations:

\dot{x}₁=x₂ (Eq. 9.1)

\dot{x}₂=x₃=−D·x₂−Ω²·x₁ (Eq. 9.2)

where:

x₁: amplitude/angle

x₂: angular velocity/rate

x₃: angular acceleration

D: damping

Ω: angular frequency

In discrete from this give the following equations:

x₁(k+1)=x₁(k)+x₂(k)·dt (Eq. 10.1)

x₂(k+1)=x₂(k)+x₃(k)·dt (Eq. 10.2)

x₃(k+1)=−D·x₁(k)−Ω²·x₂(k) (Eq. 10.3)

Note that x₃ is not a derived variable and is not a part of the state variables as such, i.e. not updated by the innovation signal.

This gives the following transition matrix:

$$\begin{matrix}\overline{x} ( k + 1 ) = A ( k ) \cdot \overline{x} ( k ) & ( Eq . 11.1 ) \\ [ \begin{matrix}{x}_{1} ( k + 1 ) \\ {x}_{2} ( k + 1 )\end{matrix} ] = [ \begin{matrix}1 & dt \\ ( - {Ω}^{2} \cdot dt ) & ( 1 - D \cdot dt )\end{matrix} ] \cdot [ \begin{matrix}{x}_{1} ( k ) \\ {x}_{2} ( k )\end{matrix} ] & ( Eq . 11.2 )\end{matrix}$$

and the following measurement matrix:

$$\begin{matrix}z ( k ) = H ( k ) \cdot {x}_{m} ( k ) & ( Eq . 12.1 ) \\ where {x}_{m} ( k ) = [ \begin{matrix}{x}_{m 1} \\ {x}_{m 2}\end{matrix} ] = [ \begin{matrix}angle measurement \\ angular rate measurement\end{matrix} ] & ( Eq . 12.2 )\end{matrix}$$

For both angle and angular velocity measurements this will give the following H matrix:

$${H}_{1} ( k ) = [ \begin{matrix}1 & 0 \\ 0 & 1\end{matrix} ] \qquad ( Eq . 12.3 )$$

For only angle measurements we will have the following H matrix:

$${H}_{2} ( k ) = [ \begin{matrix}1 & 0 \\ 0 & 0\end{matrix} ] \qquad ( Eq . 12.4 )$$

For only angular velocity measurements we will have the following H matrix:

$${H}_{3} ( k ) = [ \begin{matrix}0 & 0 \\ 0 & 1\end{matrix} ] \qquad ( Eq . 12.5 )$$

At the use of variable gain, i.e. the elements of the 2×2 matrix K, the values are calculated by the use of full equations even if the values rapidly stabilize to constant values, which provides the following set for the K matrix:

$$K = [ \begin{matrix}{K}_{11} & {K}_{12} \\ {K}_{21} & {K}_{22}\end{matrix} ] = {\overline{P}}_{k} {{H}^{T} ( H {\overline{P}}_{k} {H}^{T} + R )}^{- 1} \qquad ( Eq . 8.2 )$$

From this it can be shown that the relationship between K₁ and K₂ can be described as a constant gain, which ensures critical damping of a steady state filter (e.g. alfa/beta filters), which gives the following:

$${K}_{2} = \frac{1}{d t} \cdot ( \frac{{K}_{1}^{2}}{( 2 - {K}_{1} )} ) \qquad ( Eq . 8.3 )$$

K₁ can, for example, be 0.5, while K₂ is 1.667.

As mentioned introductorily it is important to have control of the measurement noise to be able to calculate good estimates. From measuring instruments, such as a MRU, one can acquire information about this through measurement noise covariance. This provides us with a measurement noise covariance matrix Q being a 2×2 matrix, as follows:

$$Q = [ \begin{matrix}{Q}_{angle} & 0 \\ 0 & {Q}_{rate}\end{matrix} ] \qquad ( Eq . 13 )$$

Reference is now made to FIG. 3 which is a block diagram of a discrete Kalman filter for the present invention, based on the equations above, where D is damping and delta T indicates sampling/prediction time or the time step. Z⁻¹ indicates a time shift. The blocks containing the text SW indicates switches that are closed when a new measurement is available. As can been seen from the block diagram, the filter can receive input from measuring instruments about angle measurements and angular rate measurements, or only one of these, and based on this calculate X₁ which is position, X₂ which is velocity and X₃ which is acceleration for a given point.

As mentioned introductorily it is possible to combine measurements from several measuring instruments, such as several MRUs. There are several ways to combining these measurements.

One possible way of using measurements from several measuring instruments is to sequentially update the Kalman filter, i.e. running the correction equations in a sequence according to the arrival in time of the different measurements. This is a robust and simple method to implement and one may avoid the problem of slowly drifting, something which is important in connection with highly accurate measuring instruments, further described below. However, this method does not take the measurement covariance into consideration. Ideally, the full matrix equipments should therefore be run for each measuring instrument when using this method.

Another way is to use a method called optimal statistical mix. An optimal statistical mix is a “pseudo measurement”, provided by weighting together the measurements from the different measuring instruments. The weightings should ideally reflect the accuracy of each measuring instrument, expressed by the covariance of the measurement noise, which is given by the following:

$${y}_{m} = \frac{\frac{1}{{δ}_{1}^{2}} \cdot {y}_{1 m} + \frac{1}{{δ}_{2}^{2}} \cdot {y}_{2 m} + … \frac{1}{{δ}_{n}^{2}} \cdot {y}_{nm}}{{\sum }_{i = 1}^{N} \frac{1}{{δ}_{i}^{2}}} \qquad ( Eq . 14.1 )$$

If we take basis in two measuring instruments, such as two MRUs, which have the same measurement accuracy, a pseudo angle measurement can be calculated as follows:

$${y}_{m} = \frac{{y}_{1 m} + {y}_{2 m}}{2} \qquad ( Eq . 14.2 )$$

A method including weighting of the measurements by their covariance may lead to dangerous results when a high accuracy sensor (low measurement covariance) is slowly drifting with a time constant in the same area as the process itself. This is however prevented in the present invention, due to that the covariance is not continuously calculated, but are constant values found by calibration of the values which are used.

An alternative description of transformation of position from a body fixed (vessel fixed/body frame) to a global system which does not have this problem, is described below.

The independent oscillators in roll and pitch direction represents a model which pre-estimates, lateral and vertical movement, and velocity and acceleration in a point on a vessel relative to an average value of zero. The model is thus useful in connection with fixed coordinate system for a vessel.

To detect drifting in a position relative to a geographical coordinate system one must use a reference positioning system, such as GNSS. GNSS measurements include measurements of position and velocity for a GNSS receiver antenna. These measurements can be used for correcting position estimates for a given point onboard a vessel, when the lever arm between the position of this point and the position of the GNSS antenna is known. The position of a point Pᵢₘ^{E} onboard a vessel relative to a geographical coordinate frame can be derived from the following equation:

Pᵢₘ^{E}=P_{gps}^{E}−C_{B}^{E}r (Eq. 14.2)

where P_{gps}^{G} is the position of the GNSS antenna relative to a geographical coordinate frame, C_{B}^{E} is a transition matrix from geographical frame to body frame, and r is distance vector between measuring position and GNSS position in the body frame.

This provides the following rotational matrix from body to geographical frame:

$${C}_{B}^{E} = [ \begin{matrix}c ψc θ & - s ψ c ϕ + c ψ s θ s ϕ & s ψs ϕ + c ψ s θ c ϕ \\ s ψ c θ & c ψ c ϕ + s ψ s θ s ϕ & - c ψ s ϕ + s ψ s θ s ϕ \\ - s θ & c θ s ϕ & c θ c ϕ\end{matrix} ] \qquad ( Eq . 14.3 )$$

The method of weighting described above assumes that the measuring instruments. e.g. MRUs, are accurately mounted and arranged axially to the roll and pitch axes of the vessel. This is some times not the case and the roll and pitch measurements of measuring instruments therefore have an offset compared to an accurately mounted measuring instrument.

Reference is now made to FIG. 4 which shows a 60 second time series for roll and pitch measurements for an accurately mounted measuring instrument MRU_N and an inaccurately mounted measuring instrument MRU_U. One can here clearly see that the inaccurately mounted MRU_U has an offset compared to the accurately mounted MRU_N.

The method according to the invention therefore includes estimation and compensation for these error angles, as a result of inaccurate mounting.

If a measuring instrument, such as an accelerometer, is mounted with a small angle dΘ in relation to the horizontal planar axis, it will measure a contribution from the g vector equal to:

$$\begin{matrix}{a}_{s} = g \cdot sin ( d θ ) \approx g \cdot d θ & ( Eq . 15.1 ) \\ d θ = a sin ( \frac{{a}_{s}}{g} ) & ( Eq . 15.2 )\end{matrix}$$

The average value of the acceleration is due to a some inclined measuring instrument calculated over a certain time period, and can be used for calculating the error angles for roll and pitch measurements for each measuring instrument. The formula which is used for repeating calculation of average value is:

$${μ}_{N} = \frac{N - 1}{N} {μ}_{N - 1} + \frac{1}{N} {x}_{N} \qquad ( Eq . 16 )$$

The local value of the gravitation vector can then be calculated as an average value of the measurements of all measuring instruments mounted vertically.

Reference is now made to FIG. 5 which shows the measured roll angles from an accurately mounted measuring instrument MRU_N and an inaccurately mounted measuring instrument, in addition to the resulting weighted roll measurement used for updating the filter. Even though MRU_U here has an offset, we see that the weighted roll angle measurement provides a very good result.

Combination of angle measurements from several measuring instruments can thus be summarized in the following steps:
1. Calculating average value of the gravitation vector by using readings of vertically mounted measuring instruments,
2. Calculating average value of error angles in roll and pitch for each measuring instrument,
3. Subtracting the error angles from the roll and pitch measurements for each measuring instrument,
4. Making pseudo measurements by weighting together each corrected measurement by using measurement covariance of each measuring instrument.

The formula below illustrates how the combined roll measurements are constructed based on readings from two measuring instruments, measur1 and measur2:

$${y}_{m\_roll} = \frac{\begin{matrix}\frac{1}{{δ}_{roll - measur 1}^{2}} \cdot ( {y}_{m\_roll / measur 1} - d {Θ}_{roll / measur 1} ) + \\ \frac{1}{{δ}_{roll - measur 2}^{2}} \cdot ( {y}_{m\_roll / measur 2} - d {Θ}_{roll / measur 2} )\end{matrix}}{\frac{1}{{δ}_{roll - measur 1}^{2}} \cdot + \frac{1}{{δ}_{roll - measur 2}^{2}}} \qquad ( Eq . 17 )$$

As mentioned above the method includes estimation of frequency and time period for the movement, which can be described as follows:

$$\begin{matrix}a ( k ) = - D \cdot x ( k ) - {Ω}^{2} \cdot v ( k ) & ( Eq . 18.1 ) \\ {Ω}^{2} ( k ) = - \frac{[ a ( k ) + D \cdot x ( k ) ]}{v ( k )} & ( Eq . 18.2 ) \\ Ω = \sqrt{\frac{1}{N} {\sum }_{i = 1}^{N} {Ω}^{2} ( i )} & ( Eq . 18.3 )\end{matrix}$$

As shown the estimate is calculated for the frequency as the square root of the average value of Ω². This average value can then be used to update the frequency used in the Kalman filter, see FIG. 3, at regular intervals, e.g. each 30 second or at some other suitable update rate.

The time period is calculated as:

$$T = \frac{2 \cdot π}{Ω} \qquad ( Eq . 18.4 )$$

Both the Kalman filter having constant gain (“alfa/beta”) and the Kalman filter having full equations, i.e. variable gain, are implemented in separate simulation tools, simulated and tested based on actual measurements from an accurately mounted measuring instrument MRU_N, such as MRU, and an inaccurately mounted measuring instrument MRU_U, such as a MRU, onboard an actual vessel. The following parameters were used to estimate the roll state vector:

| | | |
|---|---|---|
| Sampling time, dt | 0.1000 | sec |
| Damping | 0.05 | sec |
| Initial omega | 0.698 | sec |
| Period | 9 | sec |

The gains for the Kalman filter having constant gain were set to:

| | |
|---|---|
| Constant K1 | 0.5000 |
| Constant K2 | 1.6667 |

Reference is now made to FIG. 6a which shows simulation results for actual measurements from measuring instruments, the estimate from the Kalman filter having constant gain and the estimate from the Kalman filter having full equations (variable gain), respectively, for roll angle for a period of 60 seconds. As can be seen, the curves are identical for any practical object.

Reference is now made to FIG. 6b which shows actual measurements from measuring instruments, the estimate from the Kalman filter having constant gain and the estimate from the Kalman filter having full equations (variable gain), respectively, for roll velocity for a period of 60 seconds, while FIG. 6c shows the same for a time period of 20 seconds.

FIGS. 6b and 6c both show that the filters provide smoothed velocity estimates with acceptable lag, but that the Kalman filter having constant gain give less time lag than the Kalman filter having variable gain.

Reference is now made to FIG. 6d which shows actual measurements from measuring instruments, the estimate from the Kalman filter having constant gain and the estimate from the Kalman filter having full equations (variable gain), respectively, for roll accelerations for a period of 60 seconds, while FIG. 6e shows the same for a time period of 12.5 seconds.

The two figures show that the curves are identical for any practical object.

Reference is now made to FIG. 7 which shows how the two Kalman filter gains K1 and K2 develop over time. As can be seen they rapidly stabilize to a steady value, i.e. after about 1.5-2 seconds.

Reference is now made to FIGS. 8a and 8b which show simulations of the estimates for angular velocity and the corresponding roll period. We here see that the value for roll omega stabilizes to a steady value after ca. 2.5-3 seconds, while the corresponding roll period stabilizes to a steady value after 2.5-3.5 seconds.

Simulations have been done for three different measurement matrices by the use of full Kalman equations, i.e. by the use of only angle measurements, angular rate measurements, and both angle and rate measurements, in addition to a simple alfa/beta filter implementation, and only angle measurement updates.

The simulations show that the proposed method for estimation of angular accelerations provides good results. This shows that there is no need to arranged several measuring instruments, such as MRUs, accelerometers or similar, for the estimation of roll angular acceleration, in addition to the measuring instruments, such as MRUs or similar, which usually already are onboard a vessel.

This further shows that there is no significant improvement in the state estimates by using angular rate and angle measurements compared to only angle measurements. As the Kalman filter gain is rapidly stabilizing to a steady state value, it is sufficient to use constant gain, i.e. there is no need to run a Kalman filter having full equations. This means that the resulting implementation of the filer becomes plain. The simulation further shows that the proposed method for combining measurements from several measuring instruments provides satisfactory results. This means that one first subtracts an estimated error angle from the “raw” measurements and next weighting them together with angular readings by using the characteristic covariance of each measuring instrument as weighting. The simulations also show that the proposed method for estimation of error angles provides satisfactorily and stable results.

The results of the simulations show therefore that the equations above will provide a good result for a method according to the invention. The method according to the invention can be summarized in the following steps:
a) acquiring measurements from one or more measuring instruments arranged in given monitoring points onboard a vessel,
b) calculating position, velocity and accelerations for given monitoring points,
c) combining measurements from an arbitrary number of measuring instruments, arranged in arbitrary points to provide transformed movements to an arbitrary number of points,
d) transforming in real time to an arbitrary number of physical or virtual points on or in the vicinity of the vessel,
e) continuously repeating the steps a)-d).

Step a) includes acquiring values/measurements from measuring instruments arranged at given monitoring points on a vessel, which measuring instruments includes one or more of the following: MRU, IMU, VRU, accelerometers, gyroscope, combined IMU/GNSS system or similar. Measurements will typically be angle, angular velocity, angular acceleration and covariance for the measuring instrument/measurements.

Step b) includes calculating position, velocity and accelerations for given monitoring points by means of a Kalman filter according to the invention. The Kalman filter according to the invention includes oscillators driven by measurements from the measuring instruments. The parameters of the oscillators in the Kalman filter are further adapted to the actual vessel based on modeling or practical measurements. The Kalman filter can further be arranged for only the use of angle measurements, only angular velocity measurements or by the use of both angular velocity measurements and angle measurements. The Kalman filter can further be arranged for constant gain or variable gain.

Step c) includes combining angle measurements from different measuring instruments. The step includes:
1. calculating the average value of the gravitational vector by using readings from vertically arranged measuring instruments,
2. calculating average value of error angles in roll and pitch for each measuring instrument,
3. subtracting the error angles from the roll and pitch measurements for each measuring instrument,
4. making pseudo measurements by weighting together each corrected measurement by using measurement covariance of each measuring instrument.

This is done with high accuracy and integrity.

Step d) includes transforming in real time forces (accelerations) to an arbitrary number of physical or virtual points on or in the vicinity of the vessel, with a high degree of accuracy. It is provided that the vessel may be considered as a rigid body and that the vessel does not perform loops or rolls as a part of its general moving pattern.

Step e) includes repeating the steps a)-d) as long as it is desired to transform forces (accelerations).

Reference is now made to FIG. 9 which is a block diagram of a system according to the invention. A system according to the invention can either be a separate system or a system which is integrated with an existing monitoring system onboard a vessel. If the system is integrated with an existing monitoring system, already existing monitors, measuring instruments, etc. can be used. The system can of course also be separate even if the vessel is provided with existing monitoring systems, if desirable. This depends on the preferences of the user. A system according to the invention thus includes measuring instruments 10, such as accelerometer, gyroscope, combined IMU/GNSS system or similar systems for measuring values in given monitoring points on the vessel. The system further includes a control device 11 arranged for acquiring measurements from the measuring instruments 10, and provided with means and/or software for executing the method described above. The system further includes a monitor 12 for displaying the results of the calculations and monitoring of the given monitoring points on or in the vicinity of the vessel.

The control device 11 accordingly provides an interface between the user and the relevant monitor 12. The system further includes means 13 for storing registered and processed data/values. The control device 11 is further arranged for analyzing and processing the registered and processed data, and arranged for providing values/data for external systems, such as crane control systems and similar, and provide a visual and/or audible alarm if the values exceed certain limits.

### Modifications

The method can include prediction of the vessel movements in different points of the vessel based on wave reports and model the vessel movements based the wave reports (response of the vessel based on a wave spectrum). This can be utilized to find an optimal heading which the vessel should maintain for the movement in one or more points on the vessel to be as small as possible (keywords, vessel model, prediction of vessel movements ahead in time, wave report).

The method can further include monitoring of relative movement in one or more points between two vessels, e.g. between a vessel and a barge, walkway between two vessels, etc. This requires measurement of the motions on both vessel and transfer of these data to a common control device.

The method and system can also include establishment of integrity check in the system and tuning of the harmonic oscillators with regard to the characteristics of the actual vessel the system is installed on.

The system can further be arranged to transfer data to other system onboard, other vessels or onshore.

1. Method for modeling angular accelerations of a vessel, so that forces/accelerations in real time and with a high degree of accuracy can be transformed to any other point on the vessel or in the vicinity of the vessel, provided that the vessel can be considered as a rigid body and that the vessel does not perform loops or rolls as a part of its general movement pattern, characterized in that the method includes the following step:
a) acquiring measurements from one or more measuring instruments arranged in given monitoring points onboard a vessel,
b) calculating position, velocity and accelerations for given monitoring points,
c) combining measurements from an arbitrary number of measuring instruments, arranged in arbitrary points to provide transformed movements to an arbitrary number of points, d) transforming in real time to an arbitrary number of physical or virtual points on or in the vicinity of the vessel,
e) continuously repeating the steps a)-d).

2. Method according to claim 1, characterized in that step a) includes acquiring values/measurements from measuring instruments arranged at given monitoring points on a vessel, which measuring instruments includes one or more of the following: MRU, IMU, VRU, accelerometers, gyroscope, combined IMU/GNSS system or similar.

3. Method according to claim 1, characterized in that step b) includes calculating position, velocity and accelerations for given monitoring points by means of a Kalman filter according to the invention.

4. Method according to claim 3, characterized in that the Kalman filter includes oscillators driven by the measurements from the measuring instruments.

5. Method according to claim 4, characterized in that the parameters of the oscillators in the Kalman filter are adapted to the actual vessel, based on modeling or practical measurements.

6. Method according to claim 3, characterized in that the Kalman filter is arranged for only using angle measurements, only angular velocity measurements or using both angular velocity measurements and angle measurements.

7. Method according to claim 3, characterized in that the Kalman filter is arranged for constant gain or variable gain.

8. Method according to claim 1, characterized in that step c) includes combining measurements from an arbitrary number of measuring instruments arranged in arbitrary points on the vessel, to provide transformed movements to an arbitrary number of points with high accuracy and integrity.

9. Method according to claim 1, characterized in that step d) includes transforming in real time forces (accelerations) to an arbitrary number of physical or virtual points on or in the vicinity of the vessel with a high degree of accuracy.

10. Method according to claim 3, characterized in that when using measurements from several measuring instruments, the Kalman filter is updated sequentially by that measurement equations of the Kalman filter are run in a sequence according to the arrival time of the different measurements.

11. Method according to claim 1, characterized in that when using measurements from several measuring instruments, optimal statistic mix is used, provided by weighting together the measurements from the different measuring instruments, where the weighting reflects the accuracy of each measuring instrument, expressed by the measurement noise covariance.

12. Method according to claim 1, characterized in that the method further includes estimating and compensating for error angles based on the measurements of the measuring instruments, which error angles are induced by inaccurate mounting of the measuring instruments.

13. Method according to claim 3, characterized in that the method further includes estimating frequency and time period for movements based on measurements of the measuring instruments, to update the frequency used in the Kalman filter.

14. Method according to claim 1, characterized in that the method includes establishing integrity check of measurement/values of the measuring instruments, oscillators and the Kalman filter.

15. Method according to claim 4, characterized in that the method further includes tuning the harmonic oscillators with regard to the characteristic of the actual vessel.

16. System for modeling angular accelerations of a vessel, so that forces/accelerations in real time and with a high degree of accuracy can be transformed to any other point on the vessel or in the vicinity of the vessel, provided that the vessel can be considered as a rigid body and that the vessel does not perform loops or rolls as a part of its general movement pattern, which system includes a monitor (12), one or more measuring instruments (10), such as MRU, IMU, VRU, accelerometer, gyroscope, combined IMU/GLASS system or similar systems to measure values in a given monitoring point on the vessel, a control device (11) and means (13) for storing of data/values, characterized in that the control device (11) is provided with a Kalman filter provided with oscillators driven by measurements of the measuring instruments (10).

17. System according to claim 16, characterized in that the control device (11) is provided with means and/or software/algorithms for acquiring measurements from the measuring instruments (10) arranged in given monitoring points onboard a vessel.

18. System according to claim 17, characterized in that the control device (11) further is provided with means and/or software/algorithms for:
calculating position, velocity and acceleration for given monitoring points,
combining measurements from an arbitrary number of measuring instruments (10), arranged in arbitrary points to provide transformed movements to an arbitrary number of points,
transforming in real time to an arbitrary number of physical or virtual points on or in the vicinity of the vessel.

19. System according to claim 16, characterized in that the system is integrated in an existing monitoring system, a unit arranged/connected to an existing monitoring system or a separate unit.

20. System according to claim 16, characterized in that the system includes means and/or software/algorithms for one or more of:
registering data/values,
analyzing registered data,
providing an interface between user and the system,
transferring data to other systems onboard, other vessel or onshore,
integrity check in the system and tuning the harmonic oscillators with regard to the characteristic of the actual vessel the system is installed on.
